(19) United States
(12) Patent Application Publication
(10) Pub. No.: US 2006/0082297 A1
(43) Pub. Date: Apr. 20, 2006

(54) Method of preparing a lens-less LED

(75) Inventor: Alphonse D. Camp, Rochester, NY (US)

Correspondence Address: Mark g. Bocchetti;Patent Legal Staff, Eastman Kodak Company, 343 State Street, Rochester, NY, 14650-2201, US

(73) Assignee: Eastman Kodak Company

(21) Appl. No.: 10/968,589

(22) Filed: Oct. 19, 2004

(51) Int. Cl. H05B 33/04; H05B 33/10

(52) U.S. Cl. 313/512; 445/25

(57) ABSTRACT

A method to make a polished lens-less light emitting diode array entails adhesively mounting light emitting diodes to an etched circuit board. Each diode has a cathode and an anode connected to the diode. A clear polymer is added to the top of each diode and allowed to harden. A black polymer is added to the circuit board to fill the space between the diodes. The black polymer hardens and then is polished to provide a polished, lens-less light emitting diode array with a uniform, level, non-light-scattering surface.

### CROSS REFERENCE TO RELATED APPLICATIONS

1. Field of the Invention

The present embodiments relate generally to preparing a lens-less light emitting diode array. The present embodiments relate more specifically to preparing an acrylic coated lens-less light emitting diode array that enables high focused light output for a printer.

2. Background of the Invention

Typically, non-impact printers employ an array of light emitting diodes (LEDs) for exposing a photoreceptor drum surface. Minute LEDs are positioned next to a lens so that the images of the LEDs are arrayed across the surface to be illuminated. In some printers, multiple rows of LEDs may be used. As the surface moves past the line of LEDs, the LEDs are selectively activated to either emit light or not, thereby exposing or not exposing the surface of the drum in a pattern corresponding to the LEDs activated.

To obtain good resolution and image quality in such a printer, the physical dimensions of the LEDs must be quite small and very tight position tolerances must be maintained. Dimensional tolerances are often no more than a few tens of micrometers.

A problem arises for these types of LED printers in that the light from the LEDs must pass through a lens. If the lens is dirty, flawed, scratched, or otherwise not in perfect condition, the light emitted from the LEDs onto the surface is compromised.

The present embodiments provide a lens-less LED array that is a high quality light source without the use of lens that can get scratched during use.

### SUMMARY OF THE INVENTION

A present embodiment is for a method to make a polished lens-less light emitting diode array for use in a printer. Light emitting diodes are adhesively attached to an etched circuit board. Each diode has a top section and a bottom section. The bottom section is connected to the circuit board; the top section has an anode and a cathode.

A clear polymer is added to the top of each diode to form a clear cap. A black or opaque polymer is added to the circuit board to fill the space between the light emitting diodes to cover the anode and the cathode. The black polymer is not filled to the point where the cap of the clear polymer is covered. The polymers are then polished and grounded to provide a lens-less light emitting diode array with a uniform, level, non-light-scattering surface.

The present embodiments are advantageous over the prior are because the methods provide an array resistant to scratching.

### BRIEF DESCRIPTION OF THE DRAWINGS

In the detailed description of the preferred embodiments presented below, reference is made to the accompanying drawings, in which:

FIG. 1 depicts a cross section view of an LED with a cathode and anode mounted to the top of the LED.

FIG. 2 depicts a cross section view of an alternative embodiment of FIG. 1.

FIG. 3 depicts a side view of an LED with a cap of clear acrylic.

FIG. 4 depicts a cross section view of FIG. 3 further showing black polymer disposed around the diodes.

FIG. 5 depicts a cross section view of FIG. 4 further showing the black polymer grounded and polished.

FIG. 6 depicts an embodiment of an LED assembly made by a method described herein.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodied methods provide a manner to build extremely large LED arrays with high power output. The methods provide a low cost and quick way to build high power LED light arrays.

The present embodiments can be used to create a polished lens-less light emitting diode array that can produce either one color—such as green, red, or blue visible light—or to produce a combination of these colors.

The light emitting diode array is able to transmit about 90% of the light of the bare diode. This transmission rate is a dramatic improvement over normal transmissions.

An embodiment of the method to make a polished lens-less light emitting diode array involves first attaching a plurality of light emitting diodes (LEDs) to an etched circuit board. The LEDs can be attached either using an adhesive or by soldering the LED to the board.

Blue and green LEDs are typically attached to a sapphire substrate with a thermally conductive adhesive, such as Model TC-201P available from Zymet. For longer wavelength red LEDs with a bottom cathode contact, an electrically conductive adhesive, such as a silver-filled Model Epo-Tek H2OE available from Epoxy Technology, can be used. Small amounts of adhesive are typically applied by pin transfer rather than by pneumatic pressure dispensers. Lower cost manufacturing methods are envisioned with the embodied methods that can co-deposit and co-cure the two types of polymers used to make the LED array.

In a preferred embodiment, the array can be used for exposing photographic images or for slitting of photographic images. In one embodiment about thirty LEDs can be secured to the etched circuit board. The number of LEDs can vary as the size of the board or the size of the array varies. In addition, the LEDs can be secured perpendicular to the circuit board or in an angle in order to provide a directed, angled beam depending on the desire of the customer.

Each LED has a top section and a bottom section. The bottom section of each LED is attached to the circuit board. An anode and a cathode can be attached to the top section of each LED. In an alternative embodiment, the cathode can be connected to the bottom section instead of the top section. The anode is typically connected to a modulator that controls a power source. The cathode is typically connected to a grounded section.

A modulator controls the current to the LEDs. By controlling the current to the LEDs, the intensity of the light produced from the LED array can be controlled.

The method involves the applications of a clear polymer directly to the top of each LED. Preferably, the clear polymer is a liquid polymer at room temperature. The clear polymer is typically cured using ultraviolet (UV) light. The clear polymer is preferably an acrylic or an optically clear thixotropic ultraviolet curing adhesive, such as Model NEA 123 available from Norland, Inc. Any polymer that is optically clear at the wavelength of the associated diode is usable. Clear materials with a greater hardness are preferred because the harder materials are easier to polish.

Once the clear polymer has hardened on each LED, the circuit board is covered or flooded with a black polymer, typically a liquid black polymer. The black polymer is added to the circuit board to optically separate the LEDs and to eliminate cross-talk between the LEDs.

The black polymer completely fills the space between the LEDs and covers the anode and cathode, but leaves the top of the hardened clear polymer visible. The black polymer serves to passivate the anode and the cathode forming a monolithic structure. The black polymer is typically cured chemically, usually in less than five minutes. The black polymer can be an epoxy, an acrylic, or an opaque epoxy (such as EPO-Tek 320). Typically, the black polymer is applied to a depth of 25 microns so that all but the top of the LEDs are completely covered.

The hardened epoxy is then polished. The polishing step is typically performed using optical polishing powders or slurries that contain a small amount of abrasive. The polishing step is performed to make the surface a high polish, non-light scattering surface. The high polish, non-light scattering surface provides an efficient transmission of the LEDs in a highly directed fashion.

With reference to the figures, FIG. 1 depicts a top view of two LEDs 10 mounted to an etched circuit board 12. The circuit board 12 can be a printed circuit board, a standard circuit board, an etched polyamide, a polyester flexible circuit, or an etched paper impregnated with a phenolic resin. Other examples of usable circuit boards 12 are etched hybrid ceramics boards, etched diamond-like-carbon boards, and etched multilayer silicone substrates. The preferred circuit board 12 is an aluminum back plate with a thermally conducting or electrically insulating adhesive. Paper phenolic is a low cost material that can be used when heat transfer is not an issue. In a preferred embodiment, the printed circuit board can have a wire-bounded gold finish. More exotic substrates, such as hybrid ceramics, silicon, or diamond-like-carbons, can be used.

In the embodiment depicted in FIG. 1, each LED 10 has an anode 14 and a cathode 16 connected to the top section. A clear polymer 20 (not shown in FIG. 1) is disposed over each anode 14 and cathode 16 forming cap.

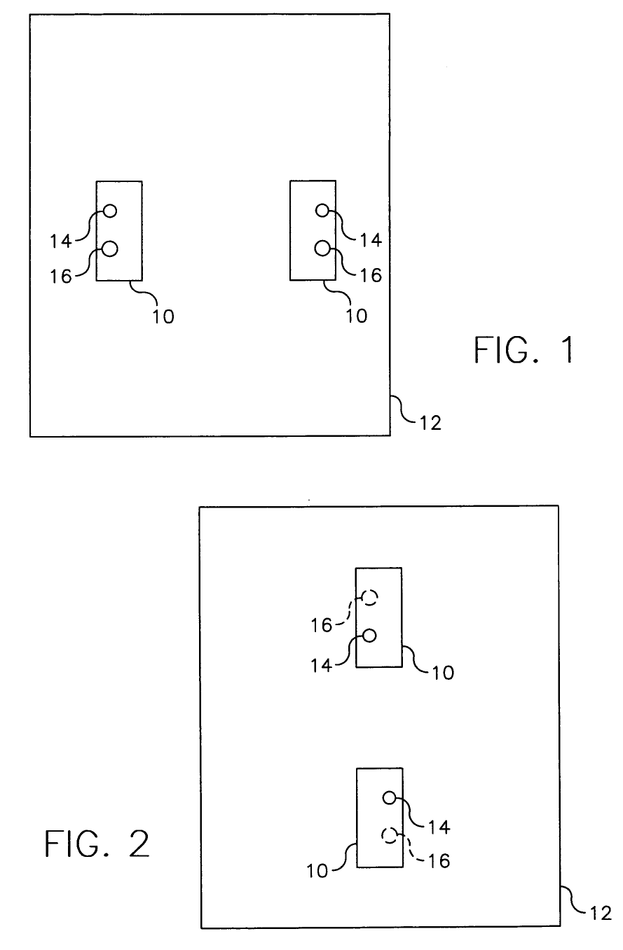

FIG. 2 shows an alternative embodiment for each LED 10 electrically connected to the circuit board 12. In one embodiment, the cathode 16 is secured to the bottom of each LED 10 rather than the top section as depicted in FIG. 1. The anode 14 is mounted to the top of each LED 10. In this embodiment, the clear polymer 20 is disposed over the anode 14 only.

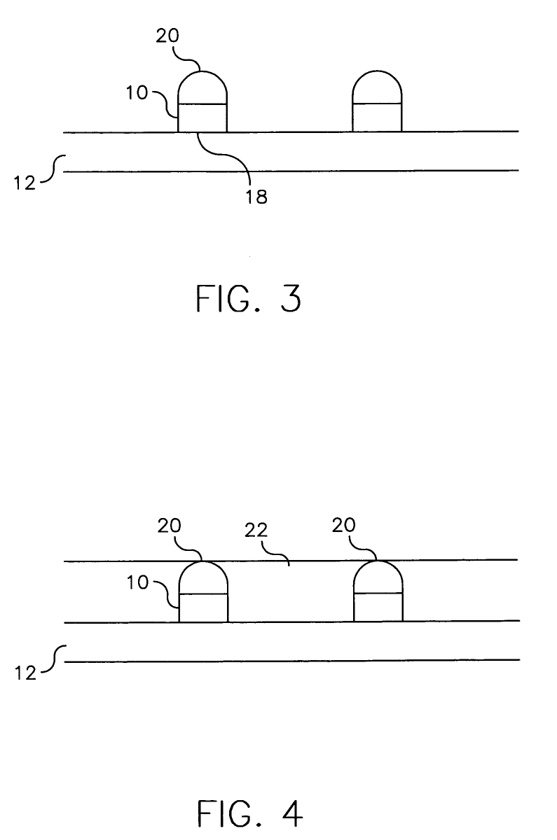

FIG. 3 depicts a cross-section of the cap formed by the hardened clear polymer 20 over the LED 10 on a circuit board 12. Typically, an adhesive 18 is used between the circuit board 12 and each LED 10 to secure each LED 10 to the circuit board 12.

FIG. 4 is a depiction of FIG. 3 wherein the black polymer 22 is added to surround each LED 10 and thereby optically isolate each LED 10 from one another other. The black polymer 22 is preferably at least thick as the LED 10 in combination with the clear polymer 20 that forms a cap on the LED 10. The black polymer 22 does not cover cap formed by the clear polymer 20.

FIG. 5 shows an embodiment of FIG. 4 wherein the clear polymer 20 and the black polymer 22 have been ground and polished to permit light from the LEDs to project from the array. The ground and polished polymers form a lens-less light emitting diode array with a uniform, level, non-light-scattering surface.

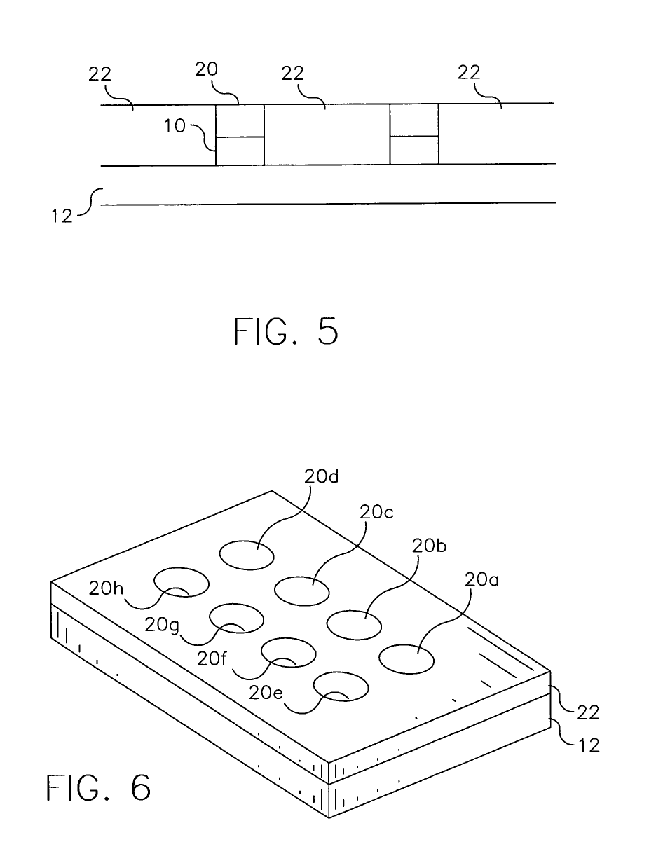

FIG. 6 shows a representative assemblage of eight LEDs 10a, 10b, 10c, 10d, 10e, 10f, 10g, 10h, not visible in the figure with the clear polymer 20a, 20b, 20c, 20d, 20e, 20f, 20g, 20h visible after the black polymer 22 has been added and the surface has been ground down and polished. The black polymer 22 fills the area between the LEDs and the clear polymers on the circuit board 12.

The invention has been described in detail with particular reference to certain preferred embodiments thereof, but it will be understood that variations and modifications can be effected within the spirit and scope of the invention.

### Parts List

10. LED
10a. LED
10b. LED
10c. LED
10d. LED
10e. LED
10f. LED
10g. LED
10h. LED
12. circuit board
14. anode
16. cathode
18. adhesive
20. clear polymer
20a. clear polymer
20b. clear polymer
20c. clear polymer
20d. clear polymer
20e. clear polymer
20f. clear polymer
20g. clear polymer
20h. clear polymer
22. black polymer

1. A method to make a polished lens-less light emitting diode array, wherein the method comprises the steps of:
a. attaching a plurality of light emitting diodes to an etched circuit board, wherein the light emitting diodes comprise a top section and a bottom section, wherein the bottom section is adhesively mounted to the etched circuit board, and wherein an anode and a cathode are mounted to the top section;
b. applying a liquid clear polymer directly to the top of each light emitting diode;
c. flooding the etched circuit board with a liquid black polymer, wherein the liquid black polymer fills space between the light emitting diodes, covers the anode and cathode, and leaves the liquid clear polymer exposed;
d. permitting the liquid black polymer to harden; and
e. polishing the surface of the hardened black polymer to provide a polished, lens-less light emitting diode array with a uniform, level, non-light-scattering surface.

2. The method of claim 1, wherein the liquid clear polymer is an acrylic.

3. The method of claim 1, wherein the liquid clear polymer is an optically clear thixotropic ultraviolet curing adhesive.

4. The method of claim 1, wherein the liquid black polymer is an acrylic.

5. The method of claim 1, wherein the black polymer is an opaque epoxy.

6. The method of claim 1, wherein the etched circuit board is a printed circuit board, a standard circuit board, an etched polyamide, a polyester flexible circuit, or an etched paper impregnated with a phenolic resin.

7. The method of claim 1, wherein the etched circuit board is an etched hybrid ceramic, an etched diamond like carbon, or an etched multilayer silicone substrate.

8. The method of claim 1, wherein the plurality of light emitting diodes are secured to the etched circuit board with a thermally conductive adhesive or an electrically insulating adhesive.

9. A method to make a polished lens-less light emitting diode array, wherein the method comprises the steps of:
a. attaching a plurality of light emitting diodes to an etched circuit board, wherein the light emitting diodes comprise a top section and a bottom section, wherein the bottom section comprises a cathode contact and is adhesively mounted to the etched circuit board, and wherein an anode is mounted to the top section;
b. applying a liquid clear polymer directly to the top of each light emitting diode;
c. flooding the etched circuit board with a liquid black polymer, wherein the liquid black polymer fills space between the light emitting diodes, covers the anode and cathode, and leaves the liquid clear polymer exposed;
d. permitting the liquid black polymer to harden; and
e. polishing the surface of the hardened black polymer to provide a polished, lens-less light emitting diode array with a uniform, level, non-light-scattering surface.

10. The method of claim 9, wherein the liquid clear polymer is an acrylic.

11. The method of claim 9, wherein the liquid clear polymer is an optically clear thixotropic ultraviolet curing adhesive.

12. The method of claim 9, wherein the liquid black polymer is an acrylic.

13. The method of claim 9, wherein the black polymer is an opaque epoxy.

14. The method of claim 9, wherein the etched circuit board is a printed circuit board, a standard circuit board, an etched polyamide, a polyester flexible circuit, or an etched paper impregnated with a phenolic resin.

15. The method of claim 9, wherein the etched circuit board is an etched hybrid ceramic, an etched diamond like carbon, or an etched multilayer silicone substrate.

16. The method of claim 9, wherein the plurality of light emitting diodes are secured to the etched circuit board with a thermally conductive adhesive or electrically insulating adhesive.

17. A polished lens-less light emitting diode array comprising:
a. an etched circuit board;
b. a plurality of light emitting diodes mounted to the etched circuit board, wherein each diode comprises a clear acrylic; and
c. a black encapsulating polymer disposed between the light emitting diodes, wherein the polymer is adapted to prevent contact between the light emitting diodes, and wherein the polymer is adapted to be polished to form a uniform, non-light scattering surface.

18. The polished lens-less light emitting diode array of claim 17, wherein the clear acrylic cap is a hardened drop of liquid acrylic polymer.
